(19) United States
(12) Patent Application Publication
(10) Pub. No.: US 2011/0267468 A1
(43) Pub. Date: Nov. 3, 2011

(54) HANDHELD DEVICE AND METHOD FOR RECORDING ABNORMAL SITUATIONS OF VEHICLES

(75) Inventor: PING-YUAN LIN, Tu-Cheng (TW)

(73) Assignee: HON HAI PRECISION INDUSTRY CO., LTD., Tu-Cheng (TW)

(21) Appl. No.: 12/909,796

(22) Filed: Oct. 21, 2010

(30) Foreign Application Priority Data
Apr. 29, 2010 (CN) 201010160091.7

(51) Int. Cl. H04N 7/18

(52) U.S. Cl. 348/149; 348/148; 348/E07.085

(57) ABSTRACT

A handheld device monitors an abnormal situation of a vehicle in real-time, and continuously records video and audio information of the vehicle. The handheld device continuously caches the recorded video and audio information, and stores the video and audio information within a first fixed time period. The handheld device stores the video and audio information within a second fixed time period when an abnormal situation of the vehicle occurs, and the video and audio information within the second fixed time period is not covered by video and audio information recorded by the video and audio recording module.

### BACKGROUND

1. Technical Field

The present disclosure relates to communication terminals, and more particularly to a handheld device recording abnormal situations of vehicles.

2. Description of Related Art

More and more people use various types of cars for transportation every day. Correspondingly, traffic accidents are on the increase with the rise in the number of the cars. It can be difficult to analyze and know actual causes of the traffic accident because no video and audio indicating the traffic accident is recorded.

Therefore, what is needed is a solution to record video and audio information about the traffic accident.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of functional modules of one embodiment of a handheld device in accordance with the present disclosure;

FIG. 2 is a flowchart of one embodiment of a method for recording video and audio information of a vehicle during an abnormal situation of the vehicle in accordance with the present disclosure;

FIG. 3 is a schematic diagram of an abnormal situation recorded in the method of the FIG. 2;

FIGS. 4-5 are flowcharts of another embodiment of a method for recording video and audio information of a vehicle during abnormal situations of the vehicle in accordance with the present disclosure; and

FIGS. 6-7 are schematic diagrams of two abnormal situations recorded in the method of the FIG. 4-5.

### DETAILED DESCRIPTION

In general, the word “module,” as used herein, refers to logic embodied in hardware or firmware, or to a collection of software instructions, written in a program language. In one embodiment, the program language may be Java or C. One or more software instructions in the modules may be embedded in firmware, such as an EPROM. The modules described herein may be implemented as either software and/or hardware modules and may be stored in any type of computer-readable medium or other storage device.

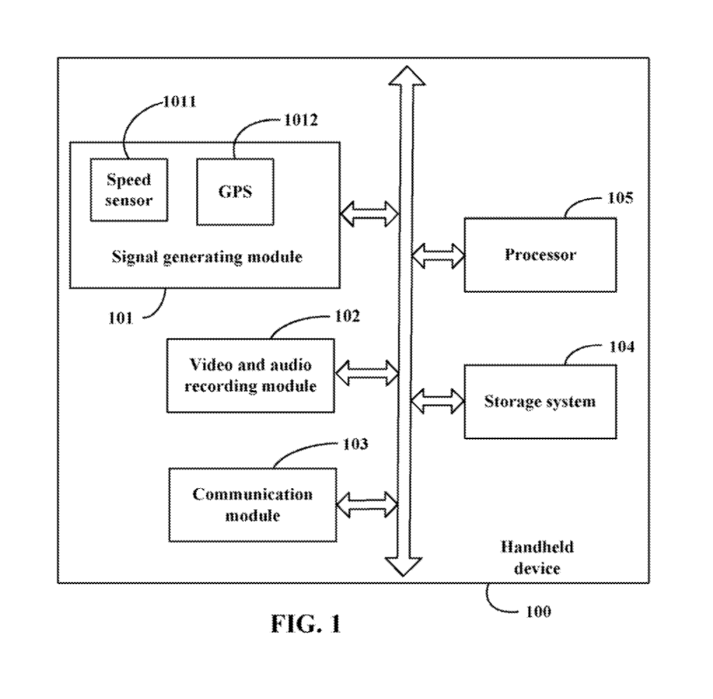

FIG. 1 is a schematic diagram of functional modules of one embodiment of a handheld device 100 in accordance with the present disclosure. In one embodiment, the handheld device 100 is operable to record video and audio information for a fixed period of when a vehicle encounters an abnormal situation, and store the video and audio information corresponding to the abnormal situation. In one embodiment, the abnormal situation of the vehicle comprises unexpected driving of the vehicle, such as an emergency braking situation, and/or a traffic accident, such as collision or rollover. The fixed time period is a time period corresponding to occurrence of the abnormal situation of the vehicle. The video and audio information within the fixed time period can be used to analyze the reasons of the abnormal situation of the vehicle.

The handheld device 100 includes a signal generating module 101, a video and audio recording module 102, a communication module 103, a storage system 104, and at least one processor 105. The modules 101-105 may comprise computerized code in the form of one or more programs that are stored in the storage system 104 (or memory). The computerized code includes instructions that are executed by the at least one processor 105 to provide functions for modules 101-105.

The signal generation module 101 is operable to monitor an abnormal situation of the vehicle in real-time when the abnormal situation occurs, and generate a corresponding trigger signal. In one embodiment, the abnormal situation includes unexpected driving of the vehicle, such as emergency braking, or a traffic accident, such as a collision or rollover. In one embodiment, the signal generating module 101 includes a speed sensor 1011 and a global positioning system (GPS) 1012. The speed sensor 1011 is operable to monitor at least one of the unexpected driving of the vehicle and the traffic accident in real-time. The global positioning system 1012 is operable to monitor locations of the vehicle so as to determine where an abnormal traffic situation occurs.

The video and audio recording module 102 is operable to continuously record video and audio information on the vehicle, and transmit the video and audio information to the storage system 104. In one embodiment, the video and audio recording module 102 may comprise a camera and a microphone.

The storage system 104 is operable to continuously caches the video and audio information recorded by the video and audio recording module 102, and stores the video and audio information that happens within a first fixed time period. The storage system 104 is further operable to store the video and audio information that happens within a second fixed time period if the abnormal situation occurs, and the video and audio information that happens within the second fixed time period not being covered. In one embodiment, the storage system 104 sets the first fixed time period and the second fixed time period in advance, and store the video and audio information according to the first fixed time period and the second fixed time period. The first fixed time period is a fixed time period before a current time, and the current time is the time of the abnormal situation occurs. The second fixed time period is a fixed time period. The second fixed time period having two equal length time period, one half time is the time period before the time of when the abnormal situation occurs, and the second half time is the time period after the time of when the abnormal situation occurs. In the embodiment, a length of the first fixed time period is longer than that of the second fixed time period.

For example, the first fixed time period is set as 20 minutes, and the second fixed time period may be set as 2 minutes. If the vehicle has an abnormal situation at 16:00, the storage system 104 caches the video and audio information from 15:40 to 16:00, and stores the video and audio information from 15:59 to 16:01. The video and audio information from 15:58 to 16:01 would not be covered by later recorded video and audio information.

Going through the abnormal situation, the storage system 104 continuously caches the video and audio information recorded by the video and audio recording module 102, and store the video and audio information that happens within a third fixed time period. In one embodiment, the third fixed time period is equal to the first fixed time period subtracting the second fixed time period. For example, if the first fixed time period is 20 minutes and the second fixed time period is 2 minutes, the third fixed time period is 18 minutes. Thus, the storage system 104 caches the latest video and audio information that happens within 18 minutes after 16:00.

The communication module 103 is operable to send a Save Our Ship (SOS) message to a hospital and to give a warning message to a driver of the vehicle when the abnormal situation occurs. In one embodiment, the SOS message includes location information accumulated by the GPS 1012.

The communication module 103 is further operable to upload the video and audio information that happens within the second fixed time period to a network storage. In this example, the second fixed time period is set as 2 minutes, the communication module 103 uploads the video and audio information that happens during 15:59 to 16:01 to a network storage.

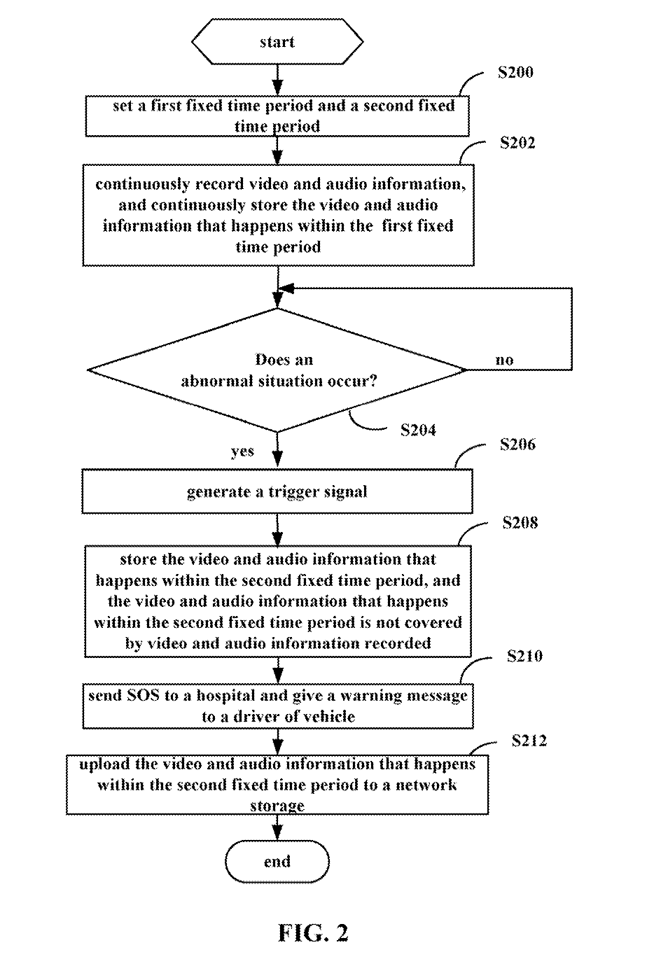

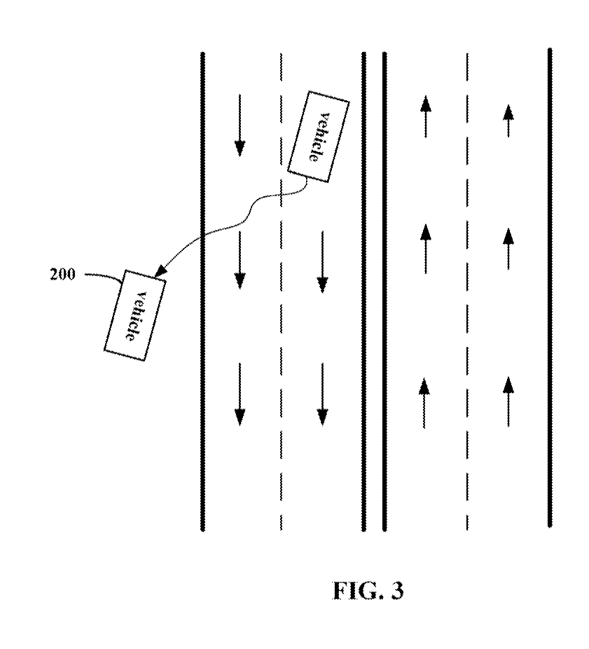

FIG. 2 is a flowchart of one embodiment of a method for recording video and audio information of a vehicle during an abnormal situation in accordance with the present disclosure. The abnormal situation of the FIG. 2 is an unexpected driving of a driver in FIG. 3, for example, an emergency sheer-off.

In block S200, the storage system 104 sets a first fixed time period as a fixed time period before a current time, the current time is the time of when the abnormal situation occurs, and sets a second fixed time period. The second fixed time period having two equal length time period, one half time is the time period before the time of when the abnormal situation occurs, the second half time is the time period after the time of when the abnormal situation occurs. In the embodiment, a length of the first fixed time period is longer than that of the second fixed time period. For example, the first fixed time period is set as 20 minutes, and the second fixed time period is set as 2 minutes.

In block S202, the video and audio recording module 102 continuously records video and audio information of the vehicle, and stores the video and audio information that happens within the first fixed time period. In this example, the video and audio recording module 102 continuously records video and audio information, and the storage system 104 continuously caches the video and audio information that happens within the latest 20 minutes.

In block S204, the signal generating module 101 monitors an abnormal situation in real-time.

If an abnormal situation occurs, in block S206, the signal generating module 101 generates a trigger signal when an abnormal situation occurs.

In block S208, the storage system 104 continuously caches the video and audio information recorded by the video and audio recording module 102, and stores the video and audio information that happens within the first fixed time period, and stores the video and audio information that happens within the second fixed time period when the trigger signal is received. The video and audio information that happens within the second fixed time period is not covered by video and audio information subsequently recorded by the video and audio recording module 102. In this example, the storage system 104 sets the first fixed time period and the second fixed time period in advance, and stores the video and audio information according to the first fixed time period and the second fixed time period. The first fixed time period is a fixed time period before a current time, and the current time is the time of when the abnormal situation occurs. The second fixed time period is a fixed time period, and the second fixed time period having two equal length time period, one half time is the time period before the time of when the abnormal situation occurs, the second half time is the time period after the time of when the abnormal situation occurs. In the embodiment, a length of the first fixed time period is longer than that of the second fixed time period. For example, the first fixed time period is set as 20 minutes, and the second fixed time period may be set as 2 minutes. If the vehicle has an abnormal situation at 16:00, the storage system 104 caches the video and audio information from 15:40 to 16:00, and stores the video and audio information from 15:59 to 16:01. The video and audio information from 15:58 to 16:01 would not be covered by later recorded video and audio information.

In block S210, the communication module 103 sends a Save Our Ship (SOS) message to a hospital and gives a warning message to a driver of the vehicle 200 when the abnormal situation occurs. In this example, the communication module 103 warns the driver of the vehicle 200 by the use of a voice that the route and/or action of the driver is abnormal, and to be careful.

In block S212, the communication module 103 uploads the video and audio information that happens within the second fixed time period to a network storage. In this example, the communication module 103 uploads the video and audio information from 15:59 to 16:01 to a network storage.

In the embodiment, the block S208-S212 may be executed at the same time or executed in sequence, and the driver can close the handheld device 100 after arriving at a destination address.

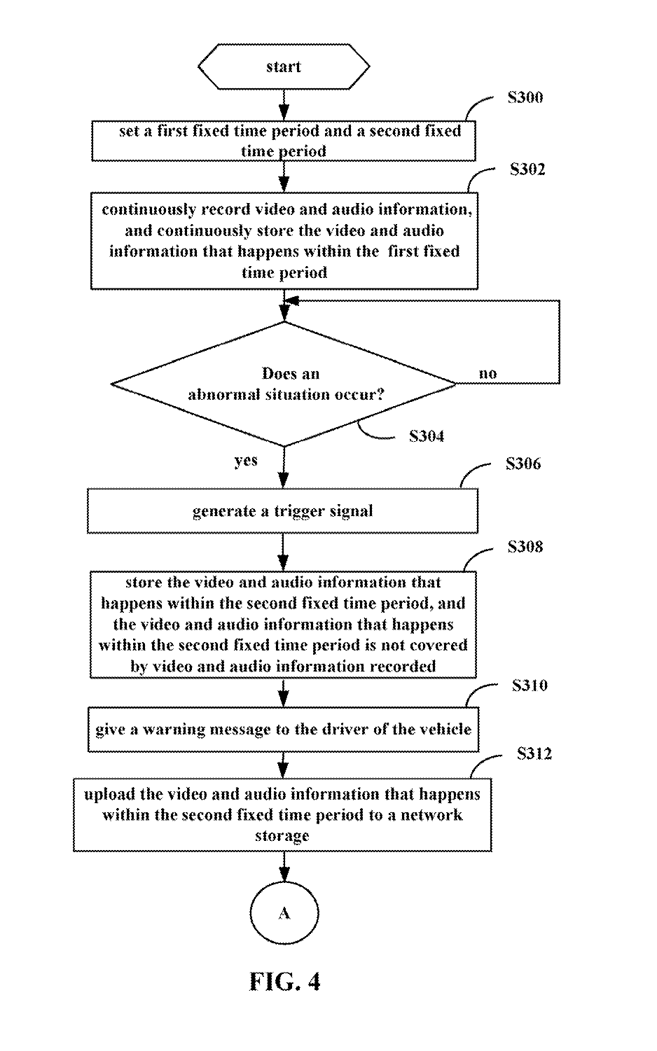

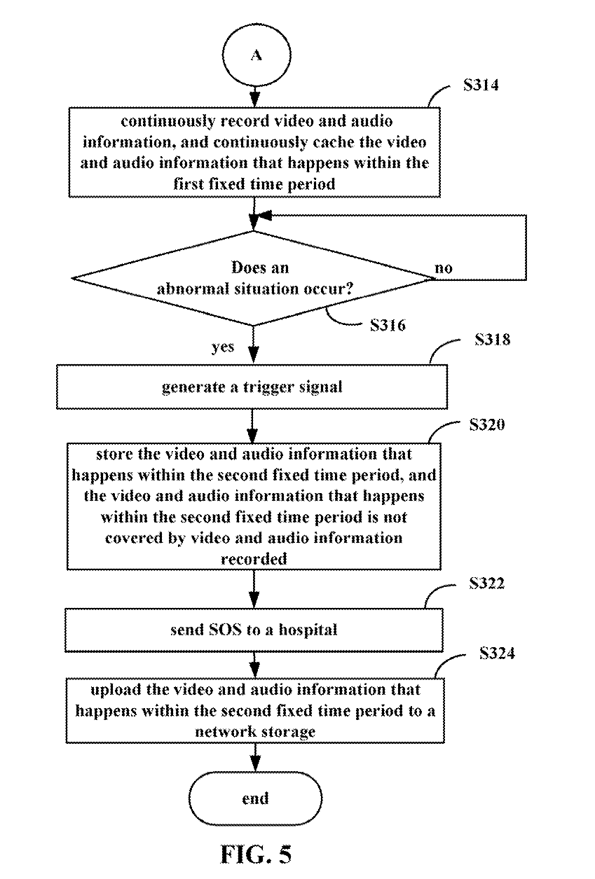

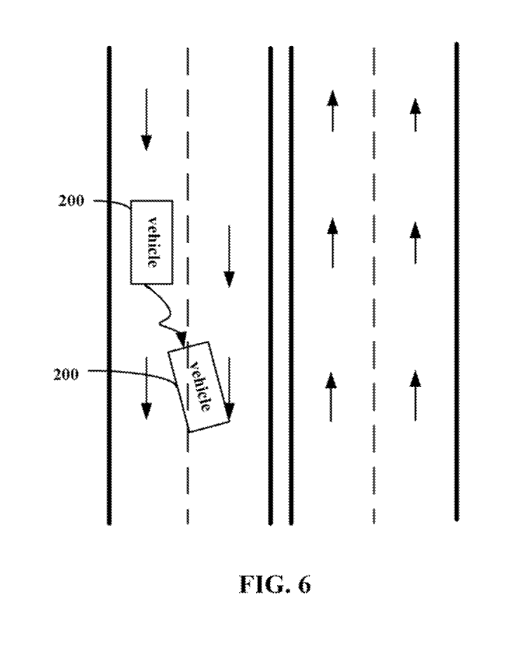

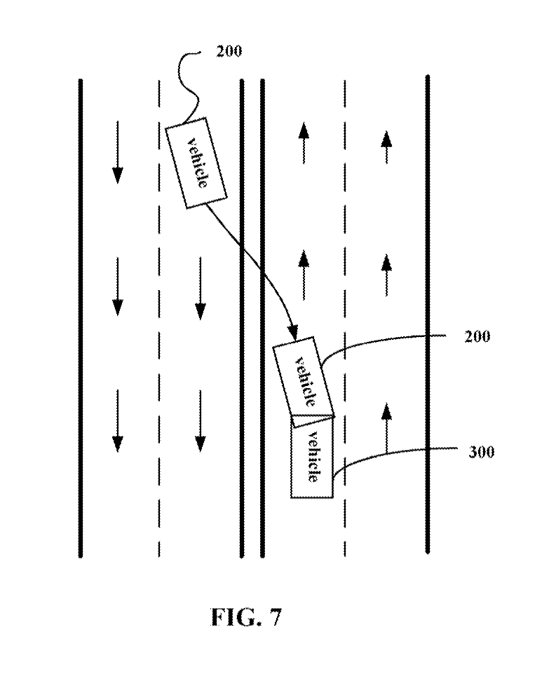

FIGS. 4-5 are flowcharts of another embodiment of a method for recording video and audio information of a vehicle during abnormal situations of the vehicle 200 in accordance with the present disclosure. In one embodiment, the abnormal situations are the unexpected driving of the vehicle and the traffic accident of FIGS. 6-7.

In block S300, the storage system 104 sets a first fixed time period as a fixed time period before a current time, and sets a second fixed time period. In the embodiment, a length of the first fixed time period is longer than that of the second fixed time period. For example, the first fixed time period is 20 minutes, and the second fixed time period is 2 minutes.

In block S302, the video and audio recording module 102 continuously records video and audio information of the vehicle 200, the storage system 104 continuously caches the video and audio information that happens within the first fixed time period. In this example, the video and audio recording module 102 continuously records the video and audio information, and the storage system 104 continuously caches the video and audio information that happens within the latest 20 minutes.

In block S304, the signal generating module 101 monitors an abnormal situation of the vehicle in real-time.

If an abnormal situation occurs, in the block S306, the signal generating module 101 generates a trigger signal. Referring to FIG. 6, for example, if the vehicle 200 has an abnormal route at 16:00, the signal generating module 101 generates a trigger signal at 16:00.

In block S308, the storage system 104 stores the video and audio information that happens within the second fixed time period when a trigger signal is received, and the video and audio information that happens within the second fixed time period is not covered by later video and audio information. In this example, the vehicle 200 has an abnormal route at 16:00, the second fixed time period is 2 minutes. Thus the storage system 104 stores the video and audio information from 15:59 to 16:01, and the video and audio information from 15:59 to 16:01 is not covered by later video and audio information recorded by the video and audio recording module 102.

In block S310, the communication module 103 gives a warning message to the driver of the vehicle 200 when the abnormal situation of the vehicle 200 occurs. In this example, the communication module 103 warns the driver of the vehicle 200 by use of voice that the route of the vehicle 200 is abnormal, and be careful of driving.

In block S312, the communication module 103 uploads the video and audio information that happens within the second fixed time period to a network storage. In this example, the second fixed time period is set as 2 minutes. Thus the communication module 103 uploads the video and audio information from 15:59 to 16:01 to a network storage.

Because the abnormal route of the vehicle 200 will not damage the vehicle 200, the driver will continue to drive the vehicle 200.

In block S314, the video and audio recording module 102 continuously records video and audio information, the storage system 104 continuously caches video and audio information that happens within a third fixed time period. In one embodiment, the third fixed time period is equal to the first fixed time period subtracting the second fixed time period. In this example, referring to FIG. 7, the first fixed time period is 20 minutes and the second fixed time period is 2 minutes, the third fixed time period is 18 minutes. Thus, the storage system 104 caches the latest video and audio information that happens within 18 minutes after 16:00.

In block S316, the signal generating module 101 monitors another abnormal situation in real-time.

If another abnormal situation occurs, in the block S318, the signal generating module 101 generates a trigger signal. Referring to FIG. 7, for example, if the vehicle 200 has an accident at 17:00, the vehicle 200 collides with the vehicle 300 in the reverse lane, the signal generating module 101 generates a trigger signal at 17:00.

In block S320, the storage system 104 stores the video and audio information that happens within the second fixed time period when a trigger signal is received, and the video and audio information within the second fixed time period is not covered by later video and audio information. Referring to FIG. 7, for example, if the vehicle 200 collides with the vehicle 300 in the reverse lane at 17:00, the second fixed time period is 2 minutes. Thus the storage system 104 stores the video and audio information from 16:59 to 17:01, and the video and audio information from 16:59 to 17:01 is not covered by video and audio information recorded by the video and audio recording module 102.

In block S322, the communication module 103 sends a Save Our Ship (SOS) message to a hospital when a trigger signal is received, the SOS message includes location information of the vehicle 200.

In block S324, the communication module 103 uploads the video and audio information that happens within the second fixed time period to a network storage. In this example, the communication module 103 uploads the video and audio information from 16:59 to 17:01 to a network storage.

In the embodiment, due to the traffic accident, the vehicle 200 would not go ahead, and the handheld device 100 shuts down automatically.

The handheld device 100 of the present disclosure can continuously record and store video and audio information of the abnormal situation both before and after the abnormal situation, and the video and audio information that happens within the fixed time period both before and after the abnormal situation is not covered by video and audio information recorded by the video and audio recording module 102.

While various embodiments of the present disclosure have been described above, it should be understood that they have been presented using example and not using limitation. Thus the breadth and scope of the present disclosure should not be limited by the above-described embodiments, but should be defined in accordance with the following claims and their equivalents.

What is claimed is:

1. A handheld device for recording video and audio information of a vehicle, the handheld device comprising:
a signal generating module operable to monitor an abnormal situation of the vehicle in real-time;
a video and audio recording module operable to continuously record video and audio information of the vehicle; and
a storage system operable to continuously cache the video and audio information, and store the video and audio information that happens within a first fixed time period, and further operable to store the video and audio information that happens within a second fixed time period when the abnormal situation of the vehicle occurs, wherein the video and audio information that happens within the second fixed time period is not covered by video and audio information subsequently recorded by the video and audio recording module; and
at least one processor operable to execute the signal generating module, the video and audio recording module.

2. The handheld device of claim 1, wherein the first fixed time period is a fixed time period before a current time, the current time is the time of the abnormal situation occurs, and the second fixed time period is a fixed time period having two equal length time period, wherein one half time is the time period before the time of when the abnormal situation occurs, and the second half time is the time period after the time of when the abnormal situation occurs.

3. The handheld device of claim 1, wherein a length of the first fixed time period is longer than that of the second fixed time period.

4. The handheld device of claim 2, wherein the storage system is further operable to continuously cache the video and audio information recorded by the video and audio recording module, and store the video and audio information that happens within a third fixed time period.

5. The handheld device of claim 4, wherein the third fixed time period is equal to the first fixed time period subtracting the second fixed time period.

6. The handheld device of claim 5, further comprising a communication module operable to send a Save Our Ship (SOS) message to a hospital and to give a warning message to a driver of the vehicle.

7. The handheld device of claim 6, wherein the communication module is further operable to upload the video and audio information that happens within the second fixed time period to a network storage.

8. The handheld device of claim 1, wherein the abnormal situation of the vehicle comprises an unexpected driving of the vehicle and/or a traffic accident.

9. The handheld device of claim 8, wherein the signal generating module further comprises a speed sensor operable to monitor at least one of the unexpected driving of the vehicle and the traffic accident in real-time.

10. The handheld device of claim 1, wherein the unexpected driving of the vehicle comprises the vehicle running along an abnormal traffic route.

11. The handheld device of claim 10, wherein the signal generating module further comprises a global positioning system operable to determine locations of the vehicle.

12. A method for recording video and audio information of a vehicle in a handheld device, the method comprising:
continuously recording video and audio information of the vehicle, and storing the video and audio information that happens within a first fixed time period;
monitoring an abnormal situation of the vehicle in real-time; and
storing the video and audio information that happens within a second fixed time period when the abnormal situation of the vehicle occurs in a storage system of the handheld device, wherein the video and audio information that happens within the second fixed time period is not covered by video and audio information subsequently recorded by the video and audio recording module.

13. The method of claim 12, further comprising:
setting the first fixed time period, wherein the first fixed time period is a fixed time period before a current time, the current time is the time of the abnormal situation occurs; and
setting the second fixed time period, wherein the second time period is a fixed time period having two equal length time period, one half time is the time period before the time of when the abnormal situation occurs, and the second half time is the time period after the time of when the abnormal situation occurs; wherein a length of the first fixed time period is longer than that of the second fixed time period.

14. The method of claim 13, further comprising:
continuously caching the video and audio information recorded by the video and audio recording module, and storing the video and audio information that happens within a third fixed time period.

15. The method of claim 14, wherein the third fixed time period is equal to the first fixed time period subtracting the second fixed time period.

16. The method of claim 15, further comprising:
sending a Save Our Ship (SOS) message to a hospital and giving a warning message to a driver of the vehicle when the abnormal situation of the vehicle occurs.

17. The method of claim 16, further comprising:
uploading the video and audio information that happens within the second fixed time period to a network storage.

18. The method of claim 17, wherein the abnormal situation of the vehicle comprises an unexpected driving of the vehicle and/or a traffic accident.

19. The method of claim 18, wherein the block of monitoring an abnormal situation of the vehicle in real-time comprising:
monitoring at least one of the unexpected driving of the vehicle and/or a traffic accident in real-time by way of a speed sensor; and
monitoring locations of the vehicle so as to determine where an abnormal traffic situation occurs by way of a global positioning system.
